(19) United States
(12) Patent Application Publication
(10) Pub. No.: US 2024/0333452 A1
(43) Pub. Date: Oct. 3, 2024

(54) COMMUNICATIONS USING ORBITAL ANGULAR MOMENTUM MODES

(71) Applicant: QUALCOMM Incorporated, San Diego, CA (US)

(72) Inventors: Min HUANG, Beijing (CN); Chao WEI, Beijing (CN); Hao XU, Beijing (CN); Danlu ZHANG, San Diego, CA (US); Sony AKKARAKARAN, Poway, CA (US)

(21) Appl. No.: 18/580,908

(22) PCT Filed: Sep. 21, 2021
(86) PCT No.: PCT/CN2021/119485

§ 371 Date: Jan. 19, 2024

(51) Int. Cl. H04L 5/00; H04L 5/14

(52) U.S. Cl. CPC H04L 5/005; H04L 5/14

(57) ABSTRACT

Various aspects of the present disclosure generally relate to wireless communication. In some aspects, an intermediate orbital angular momentum (OAM) node may receive, from a parent OAM node via a parent link between the intermediate OAM node and the parent OAM node, a first signal based at least in part on a first set of OAM modes. The intermediate OAM node may transmit, to a child OAM node via a child link between the intermediate OAM node and the child OAM node, a second signal based at least in part on a second set of OAM modes that are different than the first set of OAM modes. Numerous other aspects are described.

### FIELD OF THE DISCLOSURE

Aspects of the present disclosure generally relate to wireless communication and to techniques and apparatuses for communications using orbital angular momentum (OAM) modes.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at an intermediate orbital angular momentum (OAM) node includes a memory and one or more processors, coupled to the memory, configured to: receive, from a parent OAM node via a parent link between the intermediate OAM node and the parent OAM node, a first signal based at least in part on a first set of OAM modes; and transmit, to a child OAM node via a child link between the intermediate OAM node and the child OAM node, a second signal based at least in part on a second set of OAM modes that are different than the first set of OAM modes.

In some implementations, a method of wireless communication performed by an intermediate OAM node includes receiving, from a parent OAM node via a parent link between the intermediate OAM node and the parent OAM node, a first signal based at least in part on a first set of OAM modes; and transmitting, to a child OAM node via a child link between the intermediate OAM node and the child OAM node, a second signal based at least in part on a second set of OAM modes that are different than the first set of OAM modes.

In some implementations, a non-transitory computer-readable medium storing a set of instructions for wireless communication includes one or more instructions that, when executed by one or more processors of an intermediate OAM node, cause the intermediate OAM node to: receive, from a parent OAM node via a parent link between the intermediate OAM node and the parent OAM node, a first signal based at least in part on a first set of OAM modes; and transmit, to a child OAM node via a child link between the intermediate OAM node and the child OAM node, a second signal based at least in part on a second set of OAM modes that are different than the first set of OAM modes.

In some implementations, an intermediate OAM apparatus for wireless communication includes means for receiving, from a parent OAM apparatus via a parent link between the intermediate OAM apparatus and the parent OAM apparatus, a first signal based at least in part on a first set of OAM modes; and means for transmitting, to a child OAM apparatus via a child link between the intermediate OAM apparatus and the child OAM apparatus, a second signal based at least in part on a second set of OAM modes that are different than the first set of OAM modes.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of orbital angular momentum (OAM) waves, in accordance with the present disclosure.

FIG. 4 is a diagram illustrating an example of communication distances between OAM nodes, in accordance with the present disclosure.

FIG. 5 is a diagram illustrating an example of multiple lined-up OAM nodes, in accordance with the present disclosure.

FIG. 6 is a diagram illustrating an example of OAM mode coordination signaling, in accordance with the present disclosure.

FIG. 7 is a diagram illustrating an example of OAM modes associated with a parent link and a child link, in accordance with the present disclosure.

FIGS. 8-9 are diagrams illustrating examples of OAM modes placed along a curved line, in accordance with the present disclosure.

FIG. 10 is a diagram illustrating an example process associated with communications using OAM modes, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

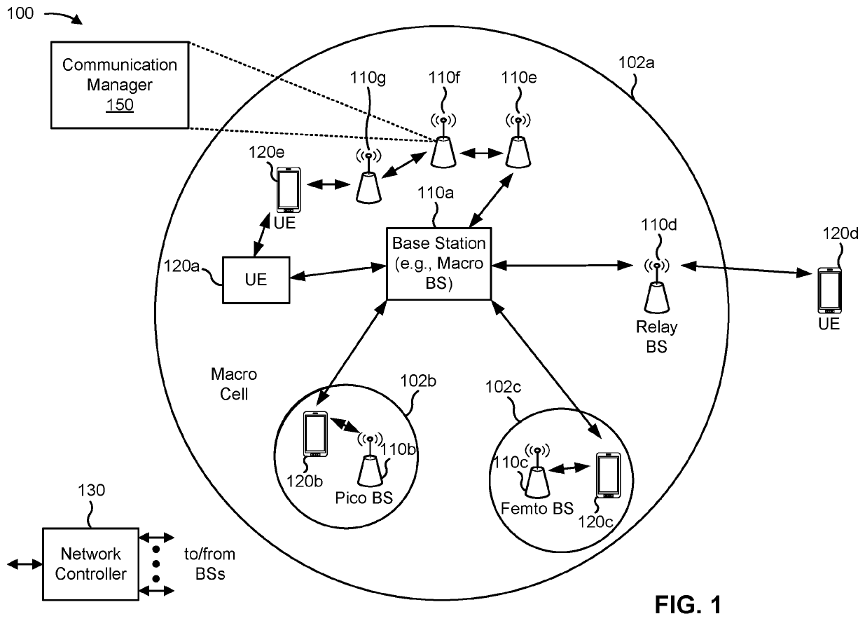

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V21) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, an intermediate orbital angular momentum (OAM) node (e.g., base station 110f) may include a communication manager 150. As described in more detail elsewhere herein, the communication manager 150 may receive, from a parent OAM node via a parent link between the intermediate OAM node and the parent OAM node, a first signal based at least in part on a first set of OAM modes; and transmit, to a child OAM node via a child link between the intermediate OAM node and the child OAM node, a second signal based at least in part on a second set of OAM modes that are different than the first set of OAM modes. Additionally, or alternatively, the communication manager 150 may perform one or more other operations described herein.

As indicated above, FIG. 1 is provided as an example. Other examples may differ from what is described with regard to FIG. 1.

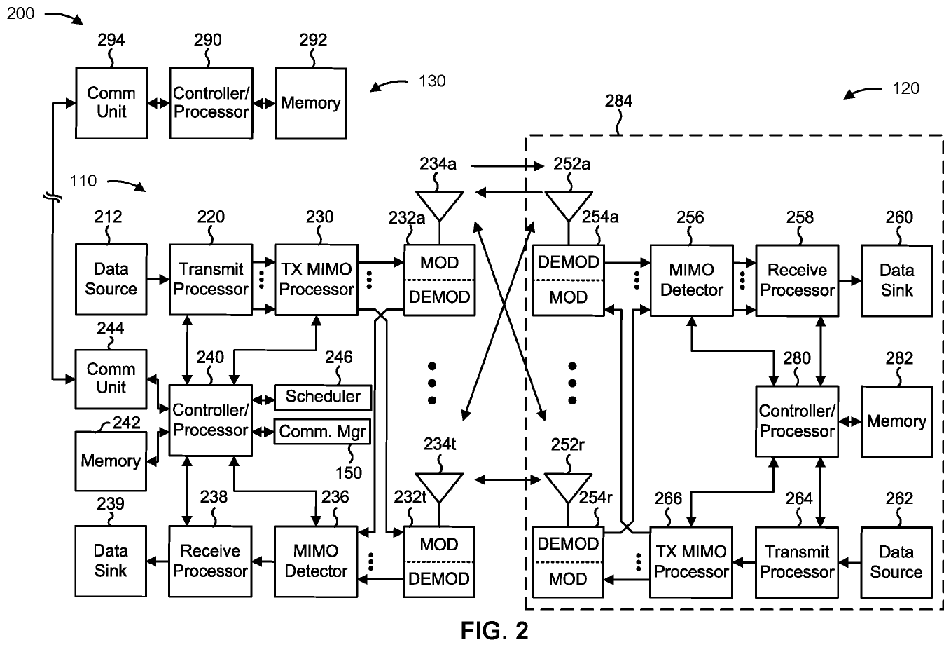

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

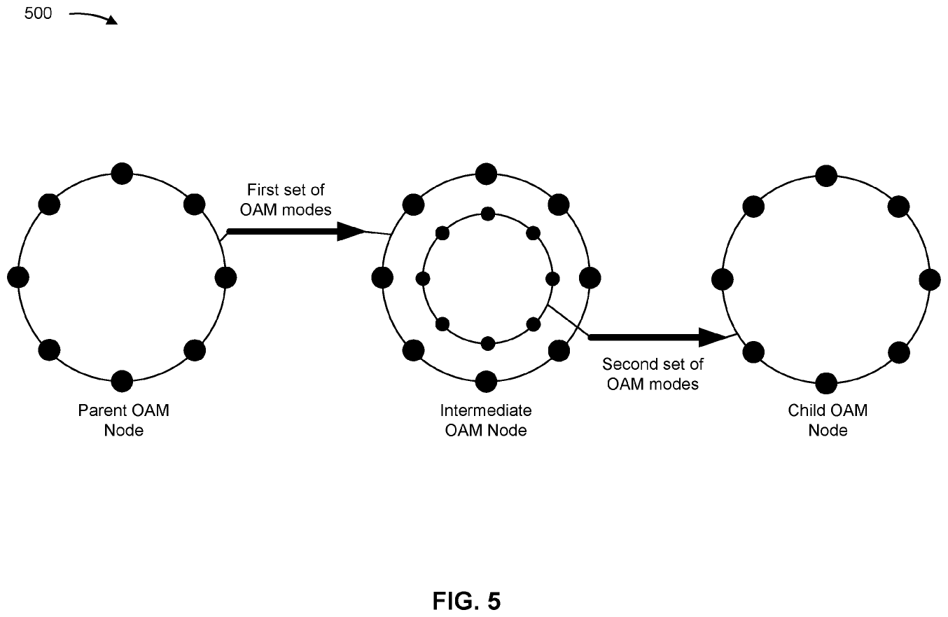

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-11).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-11).

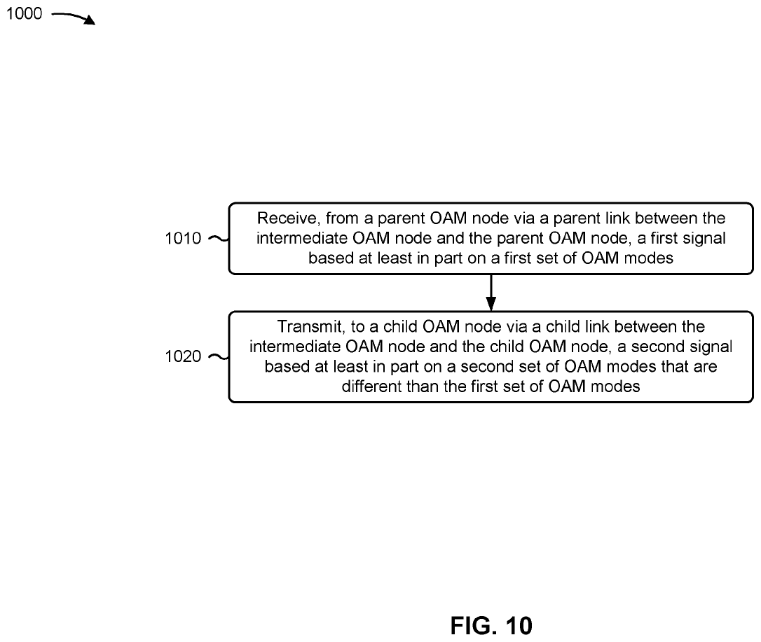

The controller/processor 240 of the base station 110, the controller/processor 280 of the UE 120, and/or any other component(s) of FIG. 2 may perform one or more techniques associated with communications using OAM modes, as described in more detail elsewhere herein. In some aspects, an OAM node (e.g., an intermediate OAM node, a parent OAM node, or a child OAM node) described herein is the base station 110, is included in the base station 110, or includes one or more components of the base station 110 shown in FIG. 2. For example, the controller/processor 240 of the base station 110, the controller/processor 280 of the UE 120, and/or any other component(s) of FIG. 2 may perform or direct operations of, for example, process 1000 of FIG. 10, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1000 of FIG. 10, and/or other processes as described herein. In some examples, executing instructions may include running the instructions, converting the instructions, compiling the instructions, and/or interpreting the instructions, among other examples.

In some aspects, an intermediate OAM node (e.g., base station 110f) includes means for receiving, from a parent OAM node via a parent link between the intermediate OAM node and the parent OAM node, a first signal based at least in part on a first set of OAM modes; and/or means for transmitting, to a child OAM node via a child link between the intermediate OAM node and the child OAM node, a second signal based at least in part on a second set of OAM modes that are different than the first set of OAM modes. In some aspects, the means for the intermediate OAM to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Future networks (e.g., 5G+, 6G, and others) may be designed to enhance various metrics, such as a peak data rate, a user experienced data rate, energy efficiency, spectral efficiency, air latency, connection density, and/or reliability. In future networks, higher data rate requirements may lead to larger bandwidths and higher frequency bands. The higher frequency bands may result in denser network nodes and additional backhauls between base stations and relays in a wireless network.

In OAM communications, a line-of-sight (LOS) transmission scheme may be provided for relatively high spatial multiplexing and relatively low complexity. In OAM communications, an OAM transmitter may transmit over an LOS channel to an OAM receiver. Between the OAM transmitter and the OAM receiver, multiple coaxially propagating and spatially-overlapping electromagnetic waves may be present, each carrying a data stream.

OAM communications may involve OAM waves. A wavefront of an OAM wave may have a helical shape. Phases of an OAM wave in a transverse plane may have the form of exp (iφl), where φ is an azimuthal angle and l is an unbounded integer (referred to as an OAM order or mode index). As an example, an OAM wave associated with OAM mode l=2, OAM mode l=1, OAM mode l=0, OAM mode l=−1, and OAM mode l=−2 may be transmitted by one transmit aperture and propagated along an axis associated with the LOS channel.

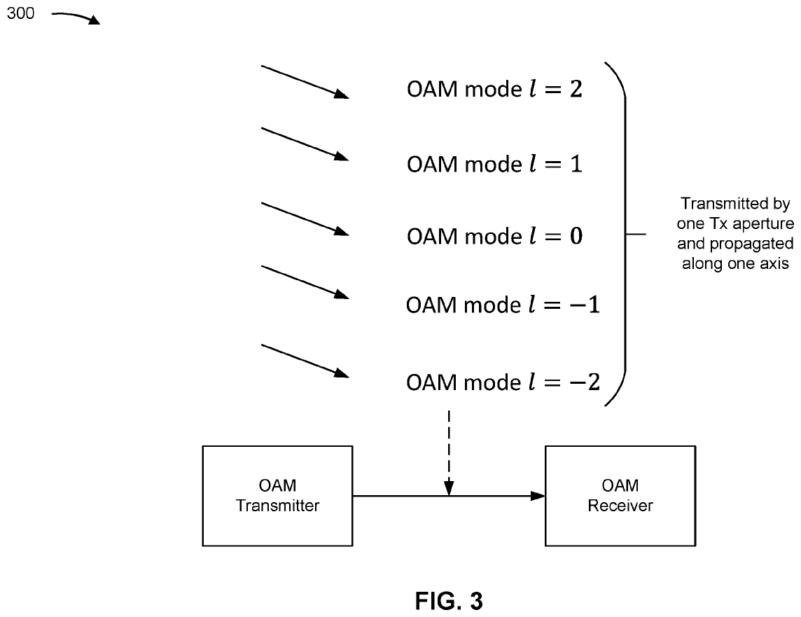

FIG. 3 is a diagram illustrating an example 300 of OAM waves, in accordance with the present disclosure.

As shown in FIG. 3, an OAM transmitter may transmit an OAM wave over an LOS channel to an OAM receiver. The OAM wave may be associated with a helical shape. Phases of the OAM wave in a transverse plane may be associated with an OAM mode. In this example, the OAM wave may be associated with OAM mode l=2, OAM mode l=1, OAM mode l=0, OAM mode l=−1, and OAM mode l=−2, which may be associated with different phases of the OAM wave.

As indicated above, FIG. 3 is provided as an example. Other examples may differ from what is described with regard to FIG. 3.

In OAM communications, helical wavefronts may be generated via a spiral phase plate (SPP), which may refer to a helical wave in a whole space between a transmitter and a receiver. Phase values at an OAM transmitter by SPP may be defined. Alternatively, helical wavefronts may be generated via a uniform circular array (UCA) antenna panel, which may be associated with a helical wave in distributed points. Received signals at antenna elements of a receiver UCA circle may have identical amplitude and progressive phases. Phase values at an OAM transmitter by UCA may be defined. Further, a UCA-based OAM may be similar to a UCA-based MIMO.

OAM communications may provide a relatively high spatial multiplexing degree in the LOS channel, which may result in relatively high data rates. Further, OAM communications may be associated with static transmitter/receiver beamforming vector weights, which may result in no need for inter-mode equalization at baseband (under direction alignment), which may lead to relatively low baseband processing complexity.

For OAM communications based at least in part on SPP, SPPs composed of high-density polyethylene (HDPE) may be used to generate and demultiplex OAM beams. An SPP may be a round plate having a thickness linearly increasing with azimuth angles. When radio waves propagate through the SPP, a spiral surface may induce different phase shifts, thereby generating a helical wave (or OAM beam) (e.g., an identical phase plane has a spiral shape). Due to different slopes of SPPs, a wave of one OAM mode may be mitigated by an OAM receiver aperture of any different OAM mode.

A utilization of SPP may generate real helical waves (OAM beams), but a same quantity of SPPs as multiplexed OAM modes may be required, which may result in a multiplex degree being restricted.

For OAM communications based at least in part on a UCA antenna panel (single circle), a UCA antenna circle may be used at the OAM transmitter to form phase-shifted received signal values at discrete element positions of a UCA antenna circle at the OAM receiver, which may realize abundant multiplexed modes in OAM communications with a practical cost.

An OAM transmitter UCA antenna circle may be used for OAM mode generation. An OAM receiver UCA circle may be used for OAM mode separation. A system setting of OAM transmitter/receiver UCA antenna circles may be co-axial. The system setting may define a same quantity of antenna elements for the OAM transmitter/receiver UCA antenna circles. The system setting may define different radiuses for the OAM transmitter/receiver UCA antenna circles. The OAM transmitter and the OAM receiver may be separated by a channel matrix H, which may be a circulant matrix, and thus its eigenvectors may be equal to discrete Fourier transform (DFT) vectors. The channel matrix H may be associated with an equivalent channel matrix A, which may be a diagonal matrix.

For OAM communications based at least in part on a UCA antenna panel (multi-circle), multiple UCA antenna circles may be used at the OAM transmitter and at the OAM receiver. The multiple UCA antenna circles may further increase a spatial multiplex degree in a radial dimension and improve a beamforming gain. A system setting for multiple OAM transmitter/receiver UCA antenna circles may involve all antenna circles being co-axial and having a same quantity of antenna elements.

At the OAM transmitter, multiple UCA antenna arrays may be used for OAM mode generation, and at the OAM receiver, multiple UCA antenna arrays may be used for OAM mode separation. The OAM transmitter and the OAM receiver may be separated by a channel matrix H, which may be a circulant matrix. The channel matrix H may be associated with an equivalent channel matrix A, which may be a block diagonal matrix.

Streams of multiple OAM modes (e.g., mode 1 and mode 2) in a first UCA antenna circle, streams of multiple OAM modes (e.g., mode 1 and mode 2) in a second UCA antenna circle, streams of multiple OAM modes (e.g., mode 1 and mode 2) in a third UCA antenna circle, streams of multiple OAM modes (e.g., mode 1 and mode 2) in a fourth UCA antenna circle, and so on may be provided to a multi-circle UCA panel, which may produce azimuth-radial two-dimensional spatial multiplexed streams. Intra-circle UCA antenna streams with different modes may be orthogonal, and inter-circle UCA antenna streams may be orthogonal with different OAM modes and non-orthogonal with the same OAM mode.

In OAM communications, a higher frequency, a larger radius, and/or a shorter distance may result in additional multiplexed OAM modes. For example, with system parameters of 64 antennas in one UCA antenna circle, a maximum of 64 transceiver units (TRXUs), a transmit power of 23/33/43 dBm, a uniform power allocation, a panel radius of 0.2/0.4 meters, a carrier frequency of 60/100 GHz, a distance of 10/50/100 meters, and one polarization, greater multiplexed OAM modes may result from the higher frequency, the larger radius, and/or the shorter distance.

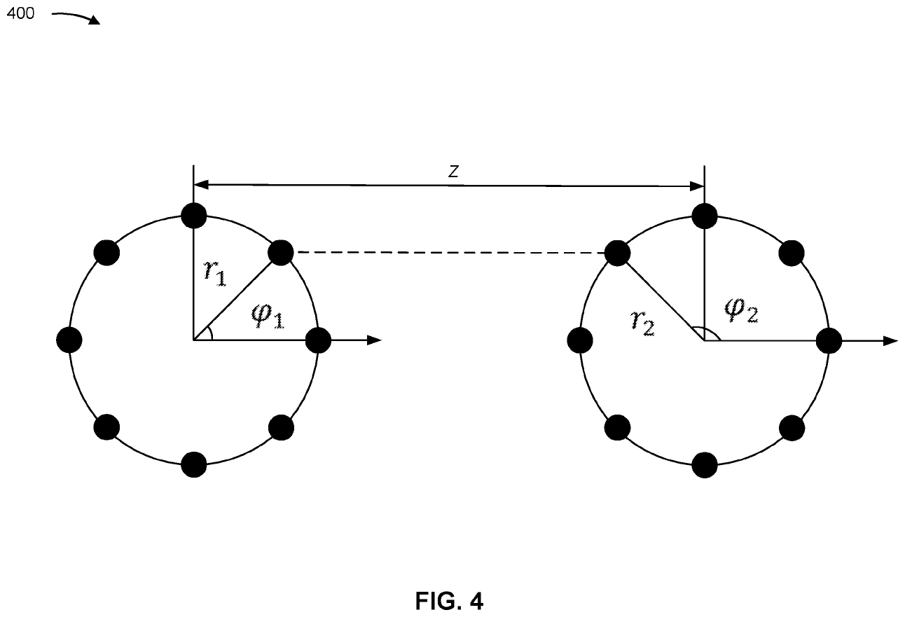

FIG. 4 is a diagram illustrating an example 400 of communication distances between OAM nodes, in accordance with the present disclosure.

A transmitter OAM node may transmit an OAM wave via an LOS channel to a receiver OAM node. Although OAM communications between the transmitter OAM node and the receiver OAM node may realize a relatively high spectrum efficiency by OAM multiplexing, a multiplexing degree may be impacted by a communication distance between the transmitter OAM node and the receiver OAM node. Since a channel gain of an OAM mode n is proportional to

$${J}_{n} ( \frac{2 π {r}_{1} {r}_{2}}{λ z} ) ,$$

where Jₙ(⋅) is the nth order of Bessel function, a longer communication distance z may result in a smaller quantity of usable OAM modes. Here, r₁ is an OAM transmitter circle radius, r₂ is an OAM receiver circle radius, z is the communication distance, and λ is the wavelength.

As an example, when the communication distance increases from 10 meters to 100 meters, a spatial multiplexing degree for a radius of 0.4 meters and a frequency of 100 GHz may decrease from approximately 42 to approximately 11, and a spectrum efficiency may also decrease from 90 bps/Hz to 60 bps/Hz.

Therefore, to realize a relatively high spectrum efficiency, the communication distance between the transmitter OAM node and the receiver OAM node may be limited due to the smaller quantity of usable OAM modes.

As indicated above, FIG. 4 is provided as an example. Other examples may differ from what is described with regard to FIG. 4.

In various aspects of techniques and apparatuses described herein, a series of OAM nodes may include a parent OAM node, an intermediate OAM node, and a child OAM node. The intermediate OAM node may receive, from the parent OAM node via a parent link between the intermediate OAM node and the parent OAM node, a first signal based at least in part on a first set of OAM modes. The intermediate OAM node may transmit, to the child OAM node via a child link between the intermediate OAM node and the child OAM node, a second signal based at least in part on a second set of OAM modes that are different than the first set of OAM modes. The first set of OAM modes and the second set of OAM modes may correspond to phases of transmitted OAM waves in a transverse plane. The first signal and the second signal may be transmitted via LOS channels between the parent OAM node and the intermediate OAM node, and between the intermediate OAM node and the child OAM node, respectively.

In some aspects, two or more OAM links may be concatenated by multiple lined-up OAM nodes (e.g., the parent OAM node, the intermediate OAM node, and the child OAM node), which may extend a high-spectrum-efficiency communication distance when OAM is used as a fronthaul/backhaul. As an example, OAM nodes may be placed along a street or a railway. The lined-up OAM nodes may provide a fronthaul/backhaul relay, as well as provide access coverage along a line area. A mode-division duplex (MDD) may be used at an intermediate (relay) OAM node to improve a total throughput from a first OAM node to a last OAM node. MDD as a kind of full duplex may realize a higher total throughput as compared to time division duplexing (TDD). Signaling messages may be used for OAM mode coordination among the lined-up OAM nodes, which may be used to determine used OAM modes at each OAM node.

FIG. 5 is a diagram illustrating an example 500 of multiple lined-up OAM nodes, in accordance with the present disclosure. As shown in FIG. 5, example 500 includes communication between a parent OAM node (e.g., base station 110e or a first OAM node), an intermediate OAM node (e.g., base station 110f or a second OAM node), and a child OAM node (e.g., base station 110g or a third OAM node). In some aspects, the parent OAM node, the intermediate OAM node, and the child OAM node may be included in a wireless network, such as wireless network 100.

In some aspects, in MDD, an intermediate OAM node (e.g., a relay OAM node or a second OAM node) may simultaneously receive a first signal from a parent OAM node (e.g., a first OAM node) and transmit a second signal to a child OAM node (e.g., a third OAM node). The intermediate OAM mode may perform the reception and the transmission based at least in part on two different OAM modes. The intermediate OAM node may include two or more UCA antenna circles (or UCA rings or UCA panels). Some UCA antenna circles of the intermediate OAM node may be used to receive a first set of OAM modes, and other UCA antenna circles of the intermediate OAM node may be used to transmit a second set of OAM modes.

In some aspects, the parent OAM node, the intermediate OAM node, and the child OAM node may be placed in a line and boresights of their respective UCA antenna circles may be co-axially aligned, which may result in receptions and transmissions being interference-free. The intermediate OAM node may transmit with OAM mode i and receive with OAM mode j, and a self-interference may be equal to fⱼ^{H}Hfᵢ, where fᵢ is an ith DFT vector. Based at least in part on OAM characteristics (H is a circulant matrix, thus DFT vectors are its eigenvectors), fⱼ^{H}Hfᵢ=0 when i≠j, and self-interference may be mitigated.

In some aspects, the intermediate OAM node may receive, from the parent OAM node via a parent link between the intermediate OAM node and the parent OAM node, the first signal based at least in part on the first set of OAM modes. The intermediate OAM node may transmit, to the child OAM node via a child link between the intermediate OAM node and the child OAM node, the second signal based at least in part on the second set of OAM modes that are different than the first set of OAM modes. The intermediate OAM node may determine the first set of OAM modes for the parent link and the second set of OAM modes for the child link from a plurality of OAM modes for MDD at the intermediate OAM node.

In some aspects, the intermediate OAM node may receive, from the parent OAM node, per-mode reference signals. A “per-mode reference signal” may be a reference signal associated with a specific OAM mode. For example, a first OAM mode may be associated with a first reference signal, a second OAM mode may be associated with a second reference signal, and so on. The intermediate OAM node may determine a set of fully used OAM modes in the parent link and a set of partially used OAM modes in the parent link based at least in part on the per-mode reference signals. The set of fully used OAM modes in the parent link and the set of partially used OAM modes in the parent link may correspond to the first set of OAM modes. The intermediate OAM node may determine a set of fully useable OAM modes in the child link and a set of partially useable OAM modes in the child link based at least in part on: a first ratio value (s), the set of fully used OAM modes in the parent link, and the set of partially used OAM modes in the parent link. The intermediate OAM node may transmit, to the child OAM node, an indication of the set of fully useable OAM modes in the child link and the set of partially useable OAM modes in the child link. The set of fully useable OAM modes in the child link may correspond to a plurality of OAM modes minus the set of fully used OAM modes in the parent link and the set of partially used OAM modes in the parent link. In other words, the set of fully useable OAM modes in the child link may be equal to a plurality of OAM modes precluding the set of fully used OAM modes in the parent link and the set of partially used OAM modes in the parent link. The set of fully useable OAM modes in the child link and the set of partially useable OAM modes in the child link may correspond to the second set of OAM modes. Further, the intermediate OAM node may transmit, to the child OAM node, a second ratio value (α=1−β) indicating a level of permitted usage, by the child OAM node, of the set of partially useable OAM modes in the child link.

In some aspects, the intermediate OAM node may receive, from the child OAM node, an indication of a total quantity of used OAM modes in the child link, where the total quantity of used OAM modes in the child link may be based at least in part on the set of fully useable OAM modes in the child link and the set of partially useable OAM modes in the child link. The intermediate OAM node may determine a total quantity of used OAM modes in the parent link based at least in part on the indication received from the child OAM node. The intermediate OAM node may transmit, to the parent OAM node, an indication of the total quantity of used OAM modes in the parent link.

In some aspects, the intermediate OAM node may determine an initial allocation of OAM modes corresponding to the first set of OAM modes and the second set of OAM modes based at least in part on an OAM channel gain. The OAM channel gain is based at least in part on: a UCA antenna panel radius associated with the parent OAM node, a UCA antenna panel radius associated with the child OAM node, a distance between the intermediate OAM node and the parent OAM node, and/or a distance between the intermediate OAM node and the child OAM node.

In some aspects, the intermediate OAM node may be a central controller node, and the intermediate OAM node may allocate a plurality of OAM modes for a plurality of OAM nodes including the parent OAM node and the child OAM node based at least in part on received indications of useable OAM modes.

In some aspects, the parent OAM node, the intermediate OAM node, and the child OAM node may be associated with a line and boresights of UCA antenna panels associated with each of the parent OAM node, the intermediate OAM node, and the child OAM node may be co-axially aligned. In some aspects, the parent OAM node, the intermediate OAM node, and the child OAM node may be associated with a curved line and boresights of UCA antenna panels associated with each of the parent OAM node, the intermediate OAM node, and the child OAM node may not be co-axially aligned. In some aspects, an OAM reception and an OAM transmission at the intermediate OAM node may be associated with a same transmit/receive UCA antenna panel based at least in part on a curved angle associated with the curved line satisfying a first threshold (e.g., the curved angle is relatively small). In some aspects, the OAM reception and the OAM transmission at the intermediate OAM node may be associated with different transmit/receive UCA antenna panels based at least in part on the curved angle associated with the curved line satisfying a second threshold (e.g., the curved angle is relatively large).

As indicated above, FIG. 5 is provided as an example. Other examples may differ from what is described with regard to FIG. 5.

In some aspects, data may be transmitted from a first OAM node (e.g., a parent OAM node) to a last OAM node (e.g., a child OAM node) using TDD or MDD. When TDD is used, at one time slot, only one OAM node may transmit with a maximum transmit power Pₜₓ. When MDD is used, at one time slot, each OAM node may transmit with a maximum transmit power Pₜₓ, and a total transmit power may be NₜₓPₜₓ, where Nₜₓ is a quantity of transmit OAM nodes.

As an example, M OAM modes may be used by three neighbor OAM nodes. For TDD, a plurality of OAM modes (e.g., all OAM modes) may be transmitted by a single OAM node (e.g., a first OAM node or a second OAM node), such that each OAM mode may use a 2Pₜₓ/M Tx power. For MDD, a first OAM node or a second OAM node may transmit M/2 OAM modes, respectively, such that each OAM mode may use a 2Pₜₓ/M Tx power. Thus, MDD may utilize more transmit power as compared to TDD, and thus may be expected to have a higher throughput as compared to TDD.

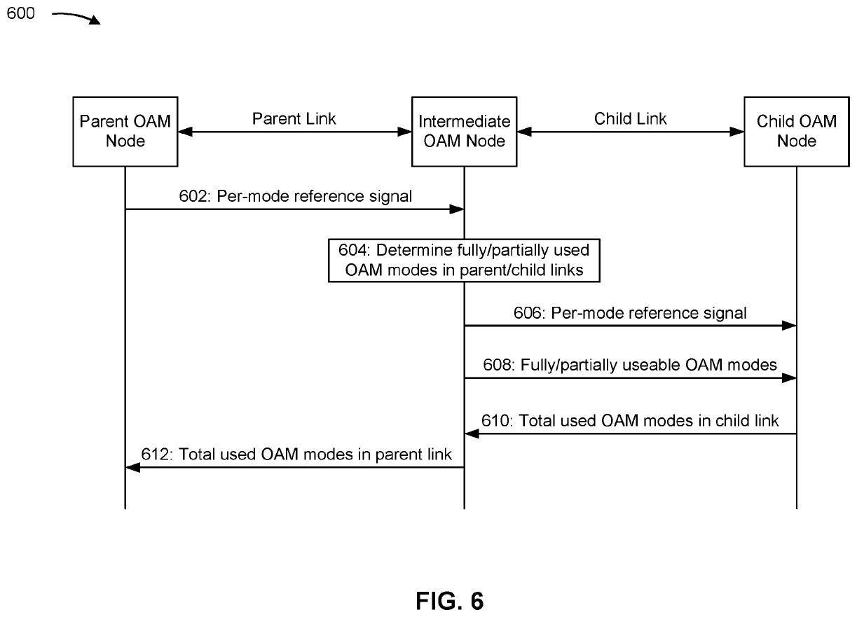

FIG. 6 is a diagram illustrating an example 600 of OAM mode coordination signaling, in accordance with the present disclosure. As shown in FIG. 6, example 600 includes communication between a parent OAM node (e.g., base station 110e or a first OAM node), an intermediate OAM node (e.g., base station 110f or a second OAM node), and a child OAM node (e.g., base station 110g or a third OAM node). In some aspects, the parent OAM node, the intermediate OAM node, and the child OAM node may be included in a wireless network, such as wireless network 100.

In some aspects, in MDD, for each intermediate OAM node (or relay OAM node), a first set of OAM modes and a second set of OAM modes may be determined for a parent link and a child link, respectively. In other words, a plurality of OAM modes may be divided for the parent link and the child link, respectively, for the intermediate OAM node. The parent link may connect the parent OAM node and the intermediate OAM node. The child link may connect the intermediate OAM node and the child OAM node.

As shown by reference number 602, the parent OAM node may transmit per-mode reference signals to the intermediate OAM node.

As shown by reference number 604, the intermediate OAM node may determine a set of fully used OAM modes and a set of partially used OAM modes in the parent link, based at least in part on the per-mode reference signals. In order to provide sufficient flexibility for OAM mode selection in the child link, the intermediate OAM node may determine the set of partially used OAM modes (e.g., only a certain ratio (denoted as β, e.g., 50%) of these OAM modes may be used).

As shown by reference number 606, the intermediate OAM node may transmit per-mode reference signals to the child OAM node.

As shown by reference number 608, the intermediate OAM node may transmit, to the child OAM node, a message indicating a set of fully usable OAM modes and a set of partially usable OAM modes (equal to the partially used OAM modes in the parent link) in the child link. In some aspects, the intermediate OAM node may further indicate a ratio (denoted as α=1−β) regarding a level of usage by the child OAM node for the set of partially usable OAM modes. The ratio may be a ratio value for the set of partially useable OAM modes. The set of fully usable OAM modes in the child link may be equal to a full set of OAM modes precluding (or excluding) sets of fully/partially used OAM modes in the parent link.

As shown by reference number 610, the child OAM node may indicate, to the intermediate OAM node, a total quantity of used OAM modes in the child link. The child OAM node may determine the total quantity of used OAM modes in the child link based at least in part on the per-mode reference signals received from the intermediate OAM node, and then indicate the total quantity of used OAM modes in the child link to the intermediate OAM node. Each of these total used OAM modes may be derived from the set of fully usable OAM modes or the set of partially usable OAM modes, where a used ratio may not be larger than an indicated ratio.

As shown by reference number 612, the intermediate OAM node may indicate, to the parent OAM node, a total quantity of used OAM modes in the parent link. The intermediate OAM node may determine the total quantity of used OAM modes in the parent link based at least in part on the indication received from the child OAM node, and then the intermediate OAM node may report the total quantity of used OAM modes in the parent link to the parent OAM node. Besides previously-determined used OAM modes, some newly-determined used OAM modes may be derived from the set of partially used OAM modes in the parent link precluding a reported total used OAM modes in the child link.

As indicated above, FIG. 6 is provided as an example. Other examples may differ from what is described with regard to FIG. 6.

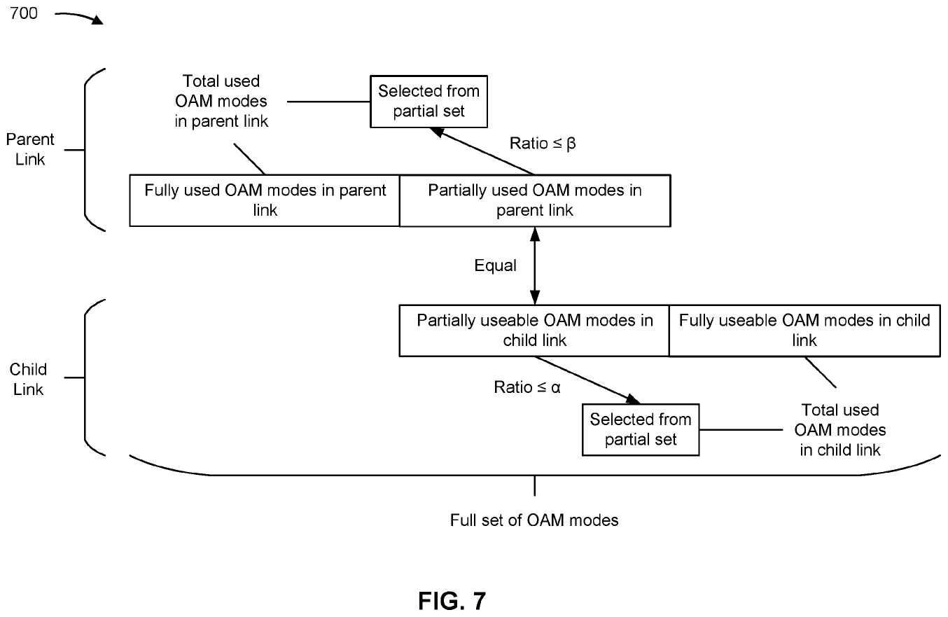

FIG. 7 is a diagram illustrating an example 700 of OAM modes associated with a parent link and a child link, in accordance with the present disclosure.

In some aspects, a parent link between a parent OAM node and an intermediate OAM node may be associated with fully used OAM modes and partially used OAM modes. OAM modes selected from the partially used OAM modes in the parent link based at least in part on a ratio≤β, along with the fully used OAM modes, may form a total quantity of used OAM modes in the parent link. In some aspects, a child link between an intermediate OAM node and a child OAM node may be associated with partially useable OAM modes and fully useable OAM modes. OAM modes selected from the partially useable OAM modes in the child link based at least in part on a ratio≤α, along with the fully useable OAM modes, may form a total quantity of used OAM modes in the parent link. In some aspects, a full set of OAM modes may be based at least in part on the fully used OAM modes in the parent link, the partially used OAM modes in the parent link, the partially useable OAM modes in the child link, and the fully useable OAM modes in the child link.

As indicated above, FIG. 7 is provided as an example. Other examples may differ from what is described with regard to FIG. 7.

In some aspects, an initial OAM mode determination may be performed. Prior to a training with a channel state information reference signal (CSI-RS), an initial allocation of OAM modes may be defined for an upstream and a downstream at an intermediate OAM node (e.g., each OAM node having a parent OAM node and a child OAM node), based at least in part on an OAM channel gain denoted by

$${J}_{n} ( \frac{2 π {r}_{1} {r}_{2}}{λ z} ) .$$

“Upstream” may refer to OAM communications between the intermediate OAM node and the parent OAM node, and “downstream” may refer to OAM communications between the intermediate OAM node and the parent OAM node. The intermediate OAM node (or each OAM node) may determine a distance to a parent OAM node and a child OAM node, as well as radiuses associated with the parent OAM node and the child OAM node, such that the intermediate OAM node is able to calculate the OAM channel gain. Distances from the intermediate OAM node to the parent OAM node and the child OAM node, respectively, may be pre-configured or measured by the intermediate OAM node. Radiuses associated with the parent OAM node and the child OAM node may be preconfigured or indicated manually to the intermediate OAM node. After determining channel gains of OAM modes, the intermediate OAM node (or each OAM node) may transmit messages to the parent OAM node and the child OAM node for OAM mode coordination.

In some aspects, the initial OAM mode determination may be followed by or be in parallel with a measurement-based OAM mode determination, as previously described. The initial OAM mode determination based at least in part on the initial allocation of OAM modes may be approximate due to various factors. For example, distances and/or panel-radiuses may be approximate, panels may not be perfectly parallel (misaligned), and/or dynamically varying interference may be present from adjacent transmissions or from access-to-backhaul interference.

In some aspects, OAM mode determination may be based at least in part on a coordination-based distributed OAM mode determination scheme (as shown in FIGS. 6-7). Alternatively, the OAM mode determination may be based at least in part on a centralized scheme. For example, a central control OAM node may collect information and determine OAM modes, even with a cascade of N intermediate OAM nodes (N>1). In some aspects, each link from a parent OAM node to a child OAM node may facilitate a CSI-RS training and report an indication of useable OAM modes and corresponding gains on the link to the central control OAM node. In some aspects, on each link, the parent OAM node and/or the child OAM node may determine link qualities if different subsets of OAM modes/antennas were unavailable due to usage by another link (e.g., a first child OAM node using subsets of OAM modes/antennas for a second child OAM node, or a first parent OAM node using subsets of OAM modes/antennas for a second parent OAM node). The parent OAM node and/or the child OAM node may report these link qualities to the central control OAM node. A plurality of reports may be indicated to the central control OAM node, which may be one of the concatenated OAM nodes (e.g., a first OAM node, a last OAM node, or an in-between OAM node), and the central control OAM node may allocate the OAM modes (as well as the α and β factors) for a plurality of links.

In some aspects, a distributed OAM mode determination or a centralized OAM mode determination may be implemented, depending on various factors. In some aspects, the distributed OAM mode determination or the centralized OAM mode determination may depend on whether a network architecture is using an integrated access and backhaul (IAB) or a sidelink relay. The JAB may be associated with centralized routing via a central unit (CU), which may be co-located with one of the OAM nodes and may serve as a central controller (or coordinator). On the other hand, the sidelink relay may operate without a central controller. In some aspects, the distributed OAM mode determination or the centralized OAM mode determination may depend on whether interference (including access-backhaul interference) is dynamic. Central coordination may be difficult in the case of dynamic interference. Further, central coordination may be more easily possible when no in-between access nodes are present and a whole chain is for backhaul from a beginning to an end.

In some aspects, when OAM nodes are placed in a straight line, Tx OAM modes and Rx OAM modes may naturally be orthogonal and/or may be kept interference-reduced or interference-free. However, in some use cases, the OAM nodes (which may include intermediate OAM nodes or relay OAM nodes) may be placed along a curved line (e.g., the OAM nodes may be placed along a curved road or river).

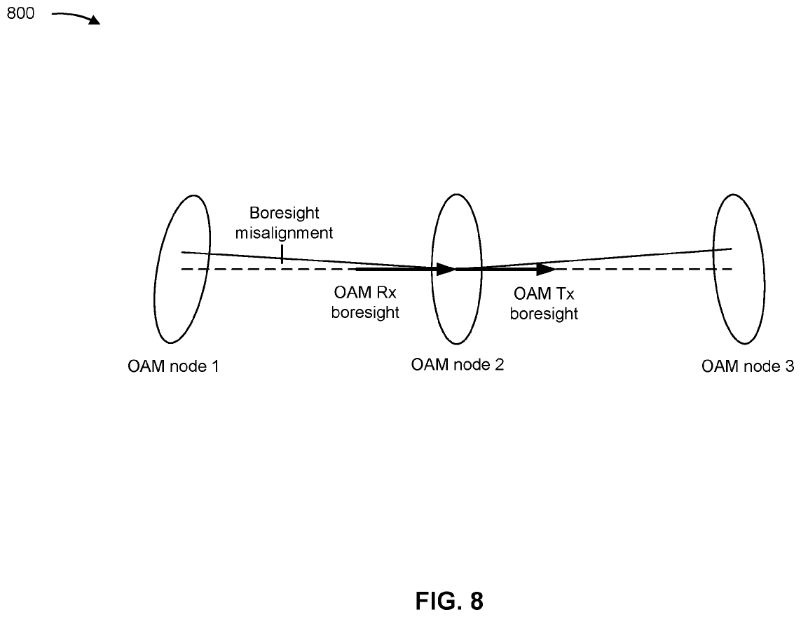

FIG. 8 is a diagram illustrating an example 800 of OAM modes placed along a curved line, in accordance with the present disclosure.

As shown in FIG. 8, a first OAM node, a second OAM node, and a third OAM node may be misaligned with respect to each other. In other words, a boresight misalignment may be present between the first OAM node, the second OAM node, and the third OAM node. The second OAM node may be associated with an OAM Rx boresight and an OAM Tx boresight, which may be misaligned with the first OAM node and the third OAM node, respectively.

In some aspects, when a curved angle is relatively small (e.g., the curved angle satisfies a first threshold), at the second OAM node (which may correspond to an intermediate OAM node or a relay OAM node), an OAM transmission and an OAM reception may use a common panel, which may result in self-interference being similar to a straight-line placement. Signals of multiple OAM modes from the first OAM node (or parent OAM node) may not be orthogonal, so additional baseband processing may be needed to separate these OAM modes.

As indicated above, FIG. 8 is provided as an example. Other examples may differ from what is described with regard to FIG. 8.

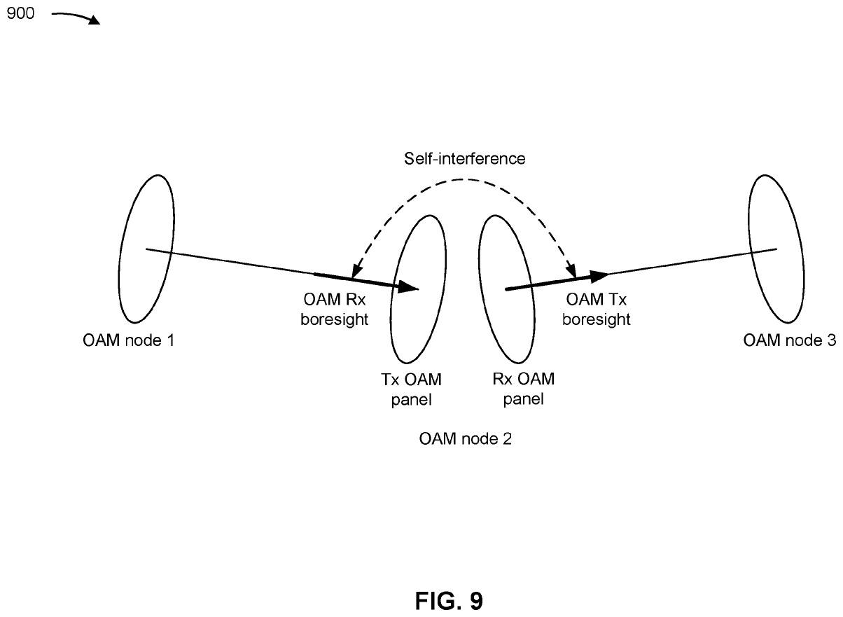

FIG. 9 is a diagram illustrating an example 900 of OAM modes placed along a curved line, in accordance with the present disclosure.

In some aspects, when a curved angle is relatively large (the curved angle satisfies a second threshold), at the second OAM node (which may correspond to an intermediate OAM node or a relay OAM node), an OAM transmission and an OAM reception may use different Tx and Rx panels. Due to a misalignment between an OAM Tx boresight and an OAM Rx boresight, separation techniques (e.g., hardware separation, or processing at RF circuit or baseband) may be implemented to reduce or eliminate self-interference (or inter-mode interference).

As indicated above, FIG. 9 is provided as an example. Other examples may differ from what is described with regard to FIG. 9.

In some aspects, concatenated OAM links may be used to extend a communication distance with relatively high data rates. An intermediate OAM node may employ MDD, which may utilize more transmit power but may produce a higher total throughput as compared to TDD. Further, signaling messages may be transmitted between the intermediate OAM node and parent/child OAM node to enable a determination or coordination of OAM modes in parent/child links of the intermediate OAM node with MDD. Information regarding partially used OAM modes in the parent link and partially usable OAM modes in the child link may provide improved flexibility when selecting proper OAM modes for both the parent link and the child link.

In some aspects, the intermediate OAM node may operate in MDD. The intermediate OAM node may transmit a message to a child OAM node of the intermediate OAM node, which may indicate a set of fully usable OAM modes and a set of partially usable OAM modes in the child link. The intermediate OAM node may further indicate a ratio α, which may indicate a level at which the child OAM node may use the set of partially usable OAM modes. Further, a procedure for a determination or coordination of OAM modes may be implemented in concatenated OAM nodes, such as the intermediate OAM node between the parent OAM node and the child OAM node.

FIG. 10 is a diagram illustrating an example process 1000 performed, for example, by an intermediate OAM node, in accordance with the present disclosure. Example process 1000 is an example where the intermediate OAM node (e.g., base station 110f) performs operations associated with communications using OAM modes.

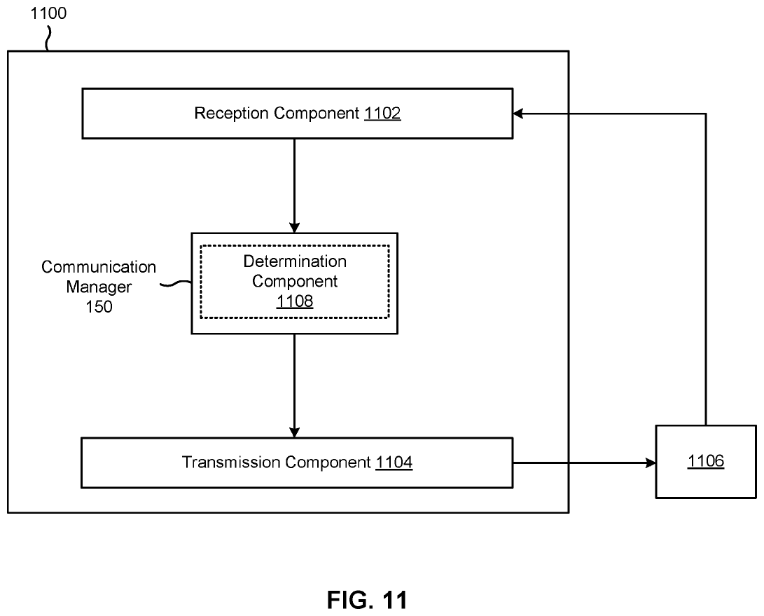

As shown in FIG. 10, in some aspects, process 1000 may include receiving, from a parent OAM node via a parent link between the intermediate OAM node and the parent OAM node, a first signal based at least in part on a first set of OAM modes (block 1010). For example, the intermediate OAM node (e.g., using communication manager 150 and/or reception component 1102, depicted in FIG. 11) may receive, from a parent OAM node via a parent link between the intermediate OAM node and the parent OAM node, a first signal based at least in part on a first set of OAM modes, as described above.

As further shown in FIG. 10, in some aspects, process 1000 may include transmitting, to a child OAM node via a child link between the intermediate OAM node and the child OAM node, a second signal based at least in part on a second set of OAM modes that are different than the first set of OAM modes (block 1020). For example, the intermediate OAM node (e.g., using communication manager 150 and/or transmission component 1104, depicted in FIG. 11) may transmit, to a child OAM node via a child link between the intermediate OAM node and the child OAM node, a second signal based at least in part on a second set of OAM modes that are different than the first set of OAM modes, as described above.

Process 1000 may include additional aspects, such as any single aspect or any combination of aspects described below and/or in connection with one or more other processes described elsewhere herein.

In a first aspect, process 1000 includes determining the first set of OAM modes for the parent link and the second set of OAM modes for the child link from a plurality of OAM modes for mode-division duplexing at the intermediate OAM node.

In a second aspect, alone or in combination with the first aspect, process 1000 includes receiving, from the parent OAM node, per-mode reference signals; determining a set of fully used OAM modes in the parent link and a set of partially used OAM modes in the parent link based at least in part on the per-mode reference signals; determining a set of fully useable OAM modes in the child link and a set of partially useable OAM modes in the child link based at least in part on a first ratio value, the set of fully used OAM modes in the parent link, and the set of partially used OAM modes in the parent link; and transmitting, to the child OAM node, an indication of the set of fully useable OAM modes in the child link and the set of partially useable OAM modes in the child link.

In a third aspect, alone or in combination with one or more of the first and second aspects, process 1000 includes receiving, from the child OAM node, an indication of a total quantity of used OAM modes in the child link, wherein the total quantity of used OAM modes in the child link is based at least in part on the set of fully useable OAM modes in the child link and the set of partially useable OAM modes in the child link; determining a total quantity of used OAM modes in the parent link based at least in part on the indication received from the child OAM node; and transmitting, to the parent OAM node, an indication of the total quantity of used OAM modes in the parent link.

In a fourth aspect, alone or in combination with one or more of the first through third aspects, process 1000 includes transmitting, to the child OAM node, a second ratio value indicating a level of permitted usage, by the child OAM node, of the set of partially useable OAM modes in the child link.

In a fifth aspect, alone or in combination with one or more of the first through fourth aspects, the set of fully useable OAM modes in the child link corresponds to a plurality of OAM modes minus the set of fully used OAM modes in the parent link and the set of partially used OAM modes in the parent link.

In a sixth aspect, alone or in combination with one or more of the first through fifth aspects, the set of fully used OAM modes in the parent link and the set of partially used OAM modes in the parent link correspond to the first set of OAM modes, and the set of fully useable OAM modes in the child link and the set of partially useable OAM modes in the child link correspond to the second set of OAM modes.

In a seventh aspect, alone or in combination with one or more of the first through sixth aspects, process 1000 includes determining an initial allocation of OAM modes corresponding to the first set of OAM modes and the second set of OAM modes based at least in part on an OAM channel gain, wherein the OAM channel gain is based at least in part on a UCA antenna panel radius associated with the parent OAM node, a UCA antenna panel radius associated with the child OAM node, a distance between the intermediate OAM node and the parent OAM node, and a distance between the intermediate OAM node and the child OAM node.

In an eighth aspect, alone or in combination with one or more of the first through seventh aspects, the intermediate OAM node is a central controller node, and process 1000 includes allocating a plurality of OAM modes for a plurality of OAM nodes including the parent OAM node and the child OAM node based at least in part on received indications of useable OAM modes.

In a ninth aspect, alone or in combination with one or more of the first through eighth aspects, the parent OAM node, the intermediate OAM node, and the child OAM node are associated with a line, and boresights of uniform circular array antenna panels associated with each of the parent OAM node, the intermediate OAM node, and the child OAM node are co-axially aligned.

In a tenth aspect, alone or in combination with one or more of the first through ninth aspects, the parent OAM node, the intermediate OAM node, and the child OAM node are associated with a curved line, and boresights of uniform circular array antenna panels associated with each of the parent OAM node, the intermediate OAM node, and the child OAM node are not co-axially aligned.

In an eleventh aspect, alone or in combination with one or more of the first through tenth aspects, an OAM reception and an OAM transmission at the intermediate OAM node are associated with a same transmit/receive uniform circular array (UCA) antenna panel based at least in part on a curved angle associated with the curved line satisfying a first threshold; or the OAM reception and the OAM transmission at the intermediate OAM node are associated with different transmit/receive UCA antenna panels based at least in part on the curved angle associated with the curved line satisfying a second threshold.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be an intermediate OAM node, or an intermediate OAM node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150. The communication manager 150 may include a determination component 1108, among other examples.

In some aspects, the apparatus 1100 may be configured to perform one or more operations described herein in connection with FIGS. 5-9. Additionally, or alternatively, the apparatus 1100 may be configured to perform one or more processes described herein, such as process 1000 of FIG. 10. In some aspects, the apparatus 1100 and/or one or more components shown in FIG. 11 may include one or more components of the intermediate OAM node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the intermediate OAM node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the intermediate OAM node described in connection with FIG. 2. In some aspects, the transmission component 1104 may be co-located with the reception component 1102 in a transceiver.

The reception component 1102 may receive, from a parent OAM node via a parent link between the intermediate OAM node and the parent OAM node, a first signal based at least in part on a first set of OAM modes. The transmission component 1104 may transmit, to a child OAM node via a child link between the intermediate OAM node and the child OAM node, a second signal based at least in part on a second set of OAM modes that are different than the first set of OAM modes.

The determination component 1108 may determine the first set of OAM modes for the parent link and the second set of OAM modes for the child link from a plurality of OAM modes for mode-division duplexing at the intermediate OAM node.

The reception component 1102 may receive, from the parent OAM node, per-mode reference signals. The determination component 1108 may determine a set of fully used OAM modes in the parent link and a set of partially used OAM modes in the parent link based at least in part on the per-mode reference signals. The determination component 1108 may determine a set of fully useable OAM modes in the child link and a set of partially useable OAM modes in the child link based at least in part on: a first ratio value, the set of fully used OAM modes in the parent link, and the set of partially used OAM modes in the parent link. The transmission component 1104 may transmit, to the child OAM node, an indication of the set of fully useable OAM modes in the child link and the set of partially useable OAM modes in the child link.

The reception component 1102 may receive, from the child OAM node, an indication of a total quantity of used OAM modes in the child link, wherein the total quantity of used OAM modes in the child link is based at least in part on the set of fully useable OAM modes in the child link and the set of partially useable OAM modes in the child link. The determination component 1108 may determine a total quantity of used OAM modes in the parent link based at least in part on the indication received from the child OAM node. The transmission component 1104 may transmit, to the parent OAM node, an indication of the total quantity of used OAM modes in the parent link.

The transmission component 1104 may transmit, to the child OAM node, a second ratio value indicating a level of permitted usage, by the child OAM node, of the set of partially useable OAM modes in the child link. The determination component 1108 may determine an initial allocation of OAM modes corresponding to the first set of OAM modes and the second set of OAM modes based at least in part on an OAM channel gain, wherein the OAM channel gain is based at least in part on: a UCA antenna panel radius associated with the parent OAM node, a UCA antenna panel radius associated with the child OAM node, a distance between the intermediate OAM node and the parent OAM node, and a distance between the intermediate OAM node and the child OAM node.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by an intermediate orbital angular momentum (OAM) node, comprising: receiving, from a parent OAM node via a parent link between the intermediate OAM node and the parent OAM node, a first signal based at least in part on a first set of OAM modes; and transmitting, to a child OAM node via a child link between the intermediate OAM node and the child OAM node, a second signal based at least in part on a second set of OAM modes that are different than the first set of OAM modes.

Aspect 2: The method of Aspect 1, further comprising: determining the first set of OAM modes for the parent link and the second set of OAM modes for the child link from a plurality of OAM modes for mode-division duplexing at the intermediate OAM node.

Aspect 3: The method of any of Aspects 1 through 2, further comprising: receiving, from the parent OAM node, per-mode reference signals; determining a set of fully used OAM modes in the parent link and a set of partially used OAM modes in the parent link based at least in part on the per-mode reference signals; determining a set of fully useable OAM modes in the child link and a set of partially useable OAM modes in the child link based at least in part on: a first ratio value, the set of fully used OAM modes in the parent link, and the set of partially used OAM modes in the parent link; and transmitting, to the child OAM node, an indication of the set of fully useable OAM modes in the child link and the set of partially useable OAM modes in the child link.

Aspect 4: The method of Aspect 3, further comprising: receiving, from the child OAM node, an indication of a total quantity of used OAM modes in the child link, wherein the total quantity of used OAM modes in the child link is based at least in part on the set of fully useable OAM modes in the child link and the set of partially useable OAM modes in the child link; determining a total quantity of used OAM modes in the parent link based at least in part on the indication received from the child OAM node; and transmitting, to the parent OAM node, an indication of the total quantity of used OAM modes in the parent link.

Aspect 5: The method of Aspect 3, further comprising: transmitting, to the child OAM node, a second ratio value indicating a level of permitted usage, by the child OAM node, of the set of partially useable OAM modes in the child link.

Aspect 6: The method of Aspect 3, wherein the set of fully useable OAM modes in the child link corresponds to a plurality of OAM modes minus the set of fully used OAM modes in the parent link and the set of partially used OAM modes in the parent link.

Aspect 7: The method of Aspect 3, wherein: the set of fully used OAM modes in the parent link and the set of partially used OAM modes in the parent link correspond to the first set of OAM modes; and the set of fully useable OAM modes in the child link and the set of partially useable OAM modes in the child link correspond to the second set of OAM modes.

Aspect 8: The method of any of Aspects 1 through 7, further comprising: determining an initial allocation of OAM modes corresponding to the first set of OAM modes and the second set of OAM modes based at least in part on an OAM channel gain, wherein the OAM channel gain is based at least in part on: a uniform circular array (UCA) antenna panel radius associated with the parent OAM node, a UCA antenna panel radius associated with the child OAM node, a distance between the intermediate OAM node and the parent OAM node, and a distance between the intermediate OAM node and the child OAM node.

Aspect 9: The method of any of Aspects 1 through 8, wherein the intermediate OAM node is a central controller node, and further comprising allocating a plurality of OAM modes for a plurality of OAM nodes including the parent OAM node and the child OAM node based at least in part on received indications of useable OAM modes.

Aspect 10: The method of any of Aspects 1 through 9, wherein the parent OAM node, the intermediate OAM node, and the child OAM node are associated with a line, and wherein boresights of uniform circular array antenna panels associated with each of the parent OAM node, the intermediate OAM node, and the child OAM node are co-axially aligned.

Aspect 11: The method of any of Aspects 1 through 10, wherein the parent OAM node, the intermediate OAM node, and the child OAM node are associated with a curved line, and wherein boresights of uniform circular array antenna panels associated with each of the parent OAM node, the intermediate OAM node, and the child OAM node are not co-axially aligned.

Aspect 12: The method of Aspect 11, wherein: an OAM reception and an OAM transmission at the intermediate OAM node are associated with a same transmit/receive uniform circular array (UCA) antenna panel based at least in part on a curved angle associated with the curved line satisfying a first threshold; or the OAM reception and the OAM transmission at the intermediate OAM node are associated with different transmit/receive UCA antenna panels based at least in part on the curved angle associated with the curved line satisfying a second threshold.

Aspect 13: An apparatus for wireless communication at a device, comprising a processor; memory coupled with the processor; and instructions stored in the memory and executable by the processor to cause the apparatus to perform the method of one or more of Aspects 1-12.

Aspect 14: A device for wireless communication, comprising a memory and one or more processors coupled to the memory, the one or more processors configured to perform the method of one or more of Aspects 1-12.

Aspect 15: An apparatus for wireless communication, comprising at least one means for performing the method of one or more of Aspects 1-12.

Aspect 16: A non-transitory computer-readable medium storing code for wireless communication, the code comprising instructions executable by a processor to perform the method of one or more of Aspects 1-12.

Aspect 17: A non-transitory computer-readable medium storing a set of instructions for wireless communication, the set of instructions comprising one or more instructions that, when executed by one or more processors of a device, cause the device to perform the method of one or more of Aspects 1-12.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at an intermediate orbital angular momentum (OAM) node, comprising:
a memory; and
one or more processors, coupled to the memory, configured to:
receive, from a parent OAM node via a parent link between the intermediate OAM node and the parent OAM node, a first signal based at least in part on a first set of OAM modes; and
transmit, to a child OAM node via a child link between the intermediate OAM node and the child OAM node, a second signal based at least in part on a second set of OAM modes that are different than the first set of OAM modes.

2. The apparatus of claim 1, wherein the one or more processors are further configured to:
determine the first set of OAM modes for the parent link and the second set of OAM modes for the child link from a plurality of OAM modes for mode-division duplexing at the intermediate OAM node.

3. The apparatus of claim 1, wherein the one or more processors are further configured to:
receive, from the parent OAM node, per-mode reference signals;
determine a set of fully used OAM modes in the parent link and a set of partially used OAM modes in the parent link based at least in part on the per-mode reference signals;
determine a set of fully useable OAM modes in the child link and a set of partially useable OAM modes in the child link based at least in part on: a first ratio value, the set of fully used OAM modes in the parent link, and the set of partially used OAM modes in the parent link; and
transmit, to the child OAM node, an indication of the set of fully useable OAM modes in the child link and the set of partially useable OAM modes in the child link.

4. The apparatus of claim 3, wherein the one or more processors are further configured to:
receive, from the child OAM node, an indication of a total quantity of used OAM modes in the child link, wherein the total quantity of used OAM modes in the child link is based at least in part on the set of fully useable OAM modes in the child link and the set of partially useable OAM modes in the child link;
determine a total quantity of used OAM modes in the parent link based at least in part on the indication received from the child OAM node; and
transmit, to the parent OAM node, an indication of the total quantity of used OAM modes in the parent link.

5. The apparatus of claim 3, wherein the one or more processors are further configured to:
transmit, to the child OAM node, a second ratio value indicating a level of permitted usage, by the child OAM node, of the set of partially useable OAM modes in the child link.

6. The apparatus of claim 3, wherein the set of fully useable OAM modes in the child link corresponds to a plurality of OAM modes minus the set of fully used OAM modes in the parent link and the set of partially used OAM modes in the parent link.

7. The apparatus of claim 3, wherein:
the set of fully used OAM modes in the parent link and the set of partially used OAM modes in the parent link correspond to the first set of OAM modes; and
the set of fully useable OAM modes in the child link and the set of partially useable OAM modes in the child link correspond to the second set of OAM modes.

8. The apparatus of claim 1, wherein the one or more processors are further configured to:
determine an initial allocation of OAM modes for the first set of OAM modes and the second set of OAM modes based at least in part on an OAM channel gain, wherein the OAM channel gain is based at least in part on: a uniform circular array (UCA) antenna panel radius associated with the parent OAM node, a UCA antenna panel radius associated with the child OAM node, a distance between the intermediate OAM node and the parent OAM node, and a distance between the intermediate OAM node and the child OAM node.

9. The apparatus of claim 1, wherein the intermediate OAM node is a central controller node, and wherein the one or more processors are further configured to allocate a plurality of OAM modes for a plurality of OAM nodes including the parent OAM node and the child OAM node based at least in part on received indications of useable OAM modes.

10. The apparatus of claim 1, wherein the parent OAM node, the intermediate OAM node, and the child OAM node are associated with a line, and wherein boresights of uniform circular array antenna panels associated with each of the parent OAM node, the intermediate OAM node, and the child OAM node are co-axially aligned.

11. The apparatus of claim 1, wherein the parent OAM node, the intermediate OAM node, and the child OAM node are associated with a curved line, and wherein boresights of uniform circular array antenna panels associated with each of the parent OAM node, the intermediate OAM node, and the child OAM node are not co-axially aligned.

12. The apparatus of claim 11, wherein:
an OAM reception and an OAM transmission at the intermediate OAM node are associated with a same transmit/receive uniform circular array (UCA) antenna panel based at least in part on a curved angle associated with the curved line satisfying a first threshold; or
the OAM reception and the OAM transmission at the intermediate OAM node are associated with different transmit/receive UCA antenna panels based at least in part on the curved angle associated with the curved line satisfying a second threshold.

13. A method of wireless communication performed by an intermediate orbital angular momentum (OAM) node, comprising:
receiving, from a parent OAM node via a parent link between the intermediate OAM node and the parent OAM node, a first signal based at least in part on a first set of OAM modes; and
transmitting, to a child OAM node via a child link between the intermediate OAM node and the child OAM node, a second signal based at least in part on a second set of OAM modes that are different than the first set of OAM modes.

14. The method of claim 13, further comprising:
determining the first set of OAM modes for the parent link and the second set of OAM modes for the child link from a plurality of OAM modes for mode-division duplexing at the intermediate OAM node.

15. The method of claim 13, further comprising:
receiving, from the parent OAM node, first per-mode reference signals;
determining a set of fully used OAM modes in the parent link and a set of partially used OAM modes in the parent link based at least in part on the per-mode reference signals;
determining a set of fully useable OAM modes in the child link and a set of partially useable OAM modes in the child link based at least in part on: a first ratio value, the set of fully used OAM modes in the parent link, and the set of partially used OAM modes in the parent link; and
transmitting, to the child OAM node, an indication of the set of fully useable OAM modes in the child link and the set of partially useable OAM modes in the child link.

16. The method of claim 15, further comprising:
receiving, from the child OAM node, an indication of a total quantity of used OAM modes in the child link, wherein the total quantity of used OAM modes in the child link is based at least in part on the set of fully useable OAM modes in the child link and the set of partially useable OAM modes in the child link;
determining a total quantity of used OAM modes in the parent link based at least in part on the indication received from the child OAM node; and
transmitting, to the parent OAM node, an indication of the total quantity of used OAM modes in the parent link.

17. The method of claim 15, further comprising:
transmitting, to the child OAM node, a second ratio value indicating a level of permitted usage, by the child OAM node, of the set of partially useable OAM modes in the child link.

18. The method of claim 15, wherein the set of fully useable OAM modes in the child link corresponds to a plurality of OAM modes minus the set of fully used OAM modes in the parent link and the set of partially used OAM modes in the parent link.

19. The method of claim 15, wherein:
the set of fully used OAM modes in the parent link and the set of partially used OAM modes in the parent link correspond to the first set of OAM modes; and
the set of fully useable OAM modes in the child link and the set of partially useable OAM modes in the child link correspond to the second set of OAM modes.

20. The method of claim 13, further comprising:
determining an initial allocation of OAM modes for the first set of OAM modes and the second set of OAM modes based at least in part on an OAM channel gain, wherein the OAM channel gain is based at least in part on: a uniform circular array (UCA) antenna panel radius associated with the parent OAM node, a UCA antenna panel radius associated with the child OAM node, a distance between the intermediate OAM node and the parent OAM node, and a distance between the intermediate OAM node and the child OAM node.

21. The method of claim 13, wherein the intermediate OAM node is a central controller node, and further comprising allocating a plurality of OAM modes for a plurality of OAM nodes including the parent OAM node and the child OAM node based at least in part on received indications of useable OAM modes.

22. The method of claim 13, wherein the parent OAM node, the intermediate OAM node, and the child OAM node are associated with a line, and wherein boresights of uniform circular array antenna panels associated with each of the parent OAM node, the intermediate OAM node, and the child OAM node are co-axially aligned.

23. The method of claim 13, wherein the parent OAM node, the intermediate OAM node, and the child OAM node are associated with a curved line, and wherein boresights of uniform circular array antenna panels associated with each of the parent OAM node, the intermediate OAM node, and the child OAM node are not co-axially aligned.

24. The method of claim 23, wherein:
an OAM reception and an OAM transmission at the intermediate OAM node are associated with a same transmit/receive uniform circular array (UCA) antenna panel based at least in part on a curved angle associated with the curved line satisfying a first threshold; or
the OAM reception and the OAM transmission at the intermediate OAM node are associated with different transmit/receive UCA antenna panels based at least in part on the curved angle associated with the curved line satisfying a second threshold.

25. A non-transitory computer-readable medium storing a set of instructions for wireless communication, the set of instructions comprising:
one or more instructions that, when executed by one or more processors of an intermediate orbital angular momentum (OAM) node, cause the intermediate OAM node to:
receive, from a parent OAM node via a parent link between the intermediate OAM node and the parent OAM node, a first signal based at least in part on a first set of OAM modes; and
transmit, to a child OAM node via a child link between the intermediate OAM node and the child OAM node, a second signal based at least in part on a second set of OAM modes that are different than the first set of OAM modes.

26. The non-transitory computer-readable medium of claim 25, wherein the one or more instructions further cause the intermediate OAM node to:
receive, from the parent OAM node, first per-mode reference signals;
determine a set of fully used OAM modes in the parent link and a set of partially used OAM modes in the parent link based at least in part on the per-mode reference signals;
determine a set of fully useable OAM modes in the child link and a set of partially useable OAM modes in the child link based at least in part on: a first ratio value, the set of fully used OAM modes in the parent link, and the set of partially used OAM modes in the parent link; and
transmit, to the child OAM node, an indication of the set of fully useable OAM modes in the child link and the set of partially useable OAM modes in the child link.

27. The non-transitory computer-readable medium of claim 26, wherein the one or more instructions further cause the intermediate OAM node to:
receive, from the child OAM node, an indication of a total quantity of used OAM modes in the child link, wherein the total quantity of used OAM modes in the child link is based at least in part on the set of fully useable OAM modes in the child link and the set of partially useable OAM modes in the child link;
determine a total quantity of used OAM modes in the parent link based at least in part on the indication received from the child OAM node; and
transmit, to the parent OAM node, an indication of the total quantity of used OAM modes in the parent link.

28. An intermediate orbital angular momentum (OAM) apparatus for wireless communication, comprising:
means for receiving, from a parent OAM apparatus via a parent link between the intermediate OAM apparatus and the parent OAM apparatus, a first signal based at least in part on a first set of OAM modes; and
means for transmitting, to a child OAM apparatus via a child link between the intermediate OAM apparatus and the child OAM apparatus, a second signal based at least in part on a second set of OAM modes that are different than the first set of OAM modes.

29. The apparatus of claim 28, further comprising:
means for receiving, from the parent OAM apparatus, first per-mode reference signals;
means for determining a set of fully used OAM modes in the parent link and a set of partially used OAM modes in the parent link based at least in part on the per-mode reference signals;
means for determining a set of fully useable OAM modes in the child link and a set of partially useable OAM modes in the child link based at least in part on: a first ratio value, the set of fully used OAM modes in the parent link, and the set of partially used OAM modes in the parent link; and
means for transmitting, to the child OAM apparatus, an indication of the set of fully useable OAM modes in the child link and the set of partially useable OAM modes in the child link.

30. The apparatus of claim 29, further comprising:
means for receiving, from the child OAM apparatus, an indication of a total quantity of used OAM modes in the child link, wherein the total quantity of used OAM modes in the child link is based at least in part on the set of fully useable OAM modes in the child link and the set of partially useable OAM modes in the child link;
means for determining a total quantity of used OAM modes in the parent link based at least in part on the indication received from the child OAM apparatus; and
means for transmitting, to the parent OAM apparatus, an indication of the total quantity of used OAM modes in the parent link.
